(19) United States
(12) Patent Application Publication
(10) Pub. No.: US 2022/0178873 A1
(43) Pub. Date: Jun. 9, 2022

(54) DUAL FUNCTION ELECTRO-OPTICAL SILICON FIELD-EFFECT TRANSISTOR MOLECULAR SENSOR

(71) Applicants: ACADEMIA SINICA, Taipei (TW); SILICON-BASED MOLECULAR SENSORING TECHNOLOGY CO., LTD., Taipei City (TW)

(72) Inventors: ChiiDong CHEN, Taipei City (TW); Pradhana Jati Budhi LAKSANA, New Taipei City (TW); Chia-Jung CHU, New Taipei City (TW)

(73) Assignees: ACADEMIA SINICA, Taipei (TW); SILICON-BASED MOLECULAR SENSORING TECHNOLOGY CO., LTD., Taipei City (TW)

(21) Appl. No.: 17/542,822

(22) Filed: Dec. 6, 2021

Related U.S. Application Data
(60) Provisional application No. 63/122,173, filed on Dec. 7, 2020.

(51) Int. Cl. G01N 27/414; G01N 27/447; B01L 3/00

(52) U.S. Cl. CPC G01N 27/4145; G01N 27/44743; G01N 27/4148; B01L 2300/0636; B01L 2300/0819; B01L 2400/0478; B01L 2300/0645; B01L 3/502715

(57) ABSTRACT

A field effect transistor (FET)-based bio-sensing system is provided. The system comprises a sensor assembly, a light source, a fluidic pump and an electrical measurement. The sensor assembly comprising an FET chip configured with at least one fluidic channel. Wherein the fluidic channel has an inlet and an outlet, and the fluidic pump is connected to the inlet of the fluidic channel and operable to drive a fluid and/or a specimen of interest through the fluidic channel. Wherein the electrical measurement unit is connected to the sensor assembly to detect a change in the electrical characteristics of the FET chip.

### BACKGROUND OF THE INVENTION

### Field of the Invention

The present invention relates to a field effect transistor (FET) and, in particular, to a dual function Electro-Optical silicon field effect transistor molecular sensor, which can detect changes in the charge distribution and optical absorption characteristics of the probe molecules associated with their interaction with the target molecules.

### Description of the Prior Art

Silicon nanowire field-effect transistors (FETs) have been used for a wide-range of biochemical detections. Taking advantage of the advanced semiconductor manufacturing industry, Si-FET bio-chips can be mass-produced at a low cost, making them a good disposable biosensors. Biosensor is a device that uses a selective reaction mechanism between biomolecules to detect dynamic interactions in the body and outside environment.

Si-FETs have shown excellent capability for the real-time observations of dynamic interactions such as DNA hybridization, protein—protein binding, cell activity, bacterial growth, and pandemic disease such as COVID-19. Generally, their detection relies on the changes in the probe molecular charge resulting from the binding between probes and targets in complex ionic solution environments. In order to prevent the molecular structure from losing activity and binding affinity, it is common to keep the analyte in a high-ionic-strength solution. Unfortunately, the Debye length, which is inversely proportional to the square root of ionic strength, is short in such solutions, and thus the electric field of the probe molecular will be screened by the high-ionic-strength solutions. This phenomenon, also known as Debye screening effect, limits useful solution concentration and hinders the development of FET sensors in clinical medical application.

The photon irradiation-induced conduction carriers in FET channels change the drain-source current, suggesting that FETs can function as optical transducers. The present disclosure found that this optical transducer capacity allows FETs to be used as optical biosensors and capable of detecting molecular binding-induced changes in the optical absorption. In this case, the issue regarding Debye screening length vis-a-vis FET charge sensors can be resolved.

### SUMMARY OF THE INVENTION

The present invention provides a field-effect-transistor (FET) based bio-sensing system, comprising a sensor assembly, a light source, a fluidic pump and an electrical measurement unit. The sensor assembly comprises an FET chip configured with at least one fluidic channel. The fluidic channel has an inlet and an outlet, and the fluidic pump is connected to the inlet of the fluidic channel and operable to drive a fluid and/or a specimen through the fluidic channel. The electrical measurement unit is connected to the sensor assembly to monitor a change in the electrical characteristics of the FET chip.

In one embodiment, the light source is a monochromator light source with a fiber connecting to the sensor assembly and/or a diode mounted on the sensor assembly.

In one embodiment, the electrical measurement unit comprises a signal amplifier, a data acquisition unit and a computer.

In one embodiment, the electrical characteristics contain information about both dark current and photocurrent; the photocurrent is the absolute value of the difference between the current under illumination of the light source and the dark current.

In one embodiment, the surface of the FET chip is modified with a linker molecule and a probe molecule.

In one embodiment, the surface of the FET chip is modified with ELISA.

In one embodiment, the specimen comprises DNA, RNA, proteins, peptides, enzymes, amino acids, antibodies, hormones, organic and inorganic pollutants, pesticides, chemicals, perfluorinated surfactants in water, or the combination thereof.

According to another embodiment of the present disclosure, a method for detecting a specimen by the above FET-based bio-sensing system is provided. The method comprises following steps:

(i) determining a working wavelength;

(ii) calibrating a response of the sensor assembly under illumination of the working wavelength;

(iii) monitoring a dark current of the specimen passing through the fluidic channel; and

(iv) monitoring a photocurrent under illumination of the working wavelength when the specimen of interest passing through the fluidic channel.

In one embodiment, the method further comprises step (v): determining an interaction between the specimen of interest and a probe molecule by analyzing the dark current and the photocurrent.

In one embodiment, step (iii) of the method further comprises:

(iii-1) modifying at least a first material on the surface of the FET chip through the fluidic channel, wherein the first material comprises the specimen; and

(iii-2) adding a second material through the fluidic channel to react with the first material, and monitoring the dark current to confirm if the first material is modified and the charge change of the reaction of first material and the second material.

In one embodiment, the change of photocurrent is due to a chemical reaction between the specimen and the probe molecule.

In one embodiment the chemical reaction is a color reaction.

In one embodiment, the color reaction is an enzymatic color reaction.

In one embodiment, the dark current corresponds to the change of the probe molecular charge.

In one embodiment, the photocurrent corresponds to the molecular absorption of the probe molecule.

In one embodiment, the dark current and the photocurrent under illumination of the working wavelength is monitored by rapidly switching the light source.

In one embodiment, the dark current is monitored when the light source is off.

In one embodiment, the photocurrent is monitored while the light source is on.

In order to make the above-mentioned and other aspects of the present invention clearer, the following specific examples are given in conjunction with the accompanying drawings for description.

In the following detailed description, for purposes of explanation, numerous specific details are set forth in order to provide a thorough understanding of the disclosed embodiments. It will be apparent, however, that one or more embodiments may be practiced without these specific details.

### BRIEF DESCRIPTION OF THE DRAWINGS

FIG. 1 (a) shows an ELISA immunosensor of the present embodiment; FIG. 1 (b) shows a FET-based charge and photon-absorption sensor for molecular sensing.

FIG. 2 (a) shows structure of a conventional FET biosensor; FIG. 2 (b) shows the FET-base bio-sensing system of the present application.

FIG. 3 (a) shows photoresponse of the FET in air; FIG. 3 (b) shows photocurrent spectrum in FIG. 3 (a).

FIG. 4 (a) shows the photocurrent spectrum under various conditions such as air, phosphate buffered saline (PBS), HRP, and HRP with TMB, FIG. 4 (b) shows the subtraction of spectra “HRP+TMB” and HRP; FIG. 4 (c) shows a comparison between the oxidized TMB photo-absorption spectrums measured using a commercial spectrophotometer (black) and a FET (red).

FIG. 5 shows the FET drain current (%) for various NGAL concentrations (a) ranging from 0.1 to 50 pg mL⁻¹ with a 50 pg mL⁻¹ BSA as a control experiment for selectivity test; and (b) drain current (%) as the function of log NGAL concentration.

FIG. 6 (a) shows the corresponding transmittance curves for different NGAL concentrations; FIG. 6 (b) shows the relation between levelling-off transmittance and the NGAL concentration; FIG. 6 (c) show the relation between the characteristic time and NGAL concentration.

### DETAILED DESCRIPTION OF THE EMBODIMENTS

The present disclosure employs high-charge sensitivity and high-photon responsivity functions of FETs for biosensing applications, namely, charge sensing to detect molecular-charge change and optical transduction to detect molecular absorption properties. In the embodiment, Neutrophil Gelatinase-Associated Lipocalin (NGAL) was selected as the target molecule for the illustration of the two functions. For many years, NGAL has been considered a promising biomarker. It is available commercially for the validation of NGAL detection in urinary tract infection (UTI). NGAL is known to be upregulated within the uroepithelium and kidneys of patients with UTI. Recurrent UTIs have been known to be associated with sudden kidney failure. Early diagnosis and timely treatment of such UTIs are important for preventing chronic kidney injuries which can lead to life-threatening illnesses. NGAL is usually detected by the enzyme-linked immunosorbent assay (ELISA) technique. The present disclosure uses the ELISA technique to demonstrate FET photodetection capabilities.

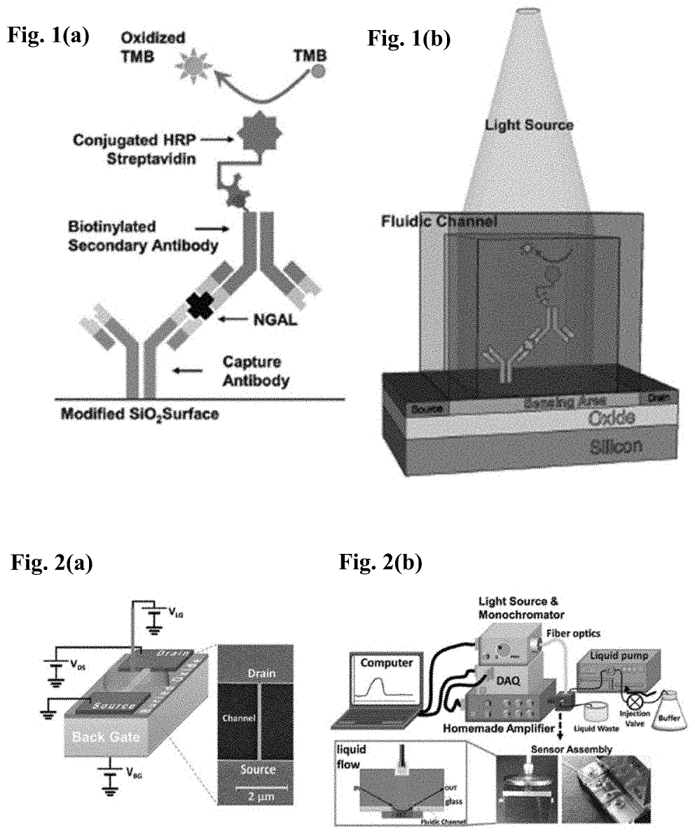

FIG. 1 (a) shows an ELISA immunosensor of the present embodiment. An ELISA sandwich structure is selected for NGAL detection. The capture antibody is covalently immobilized on the modified-silicon oxide (SiO₂) surface of the FET to detect the NGAL. A linker molecule can be used to connect the surface of the FET chip and the probe molecule. FIG. 1 (b) shows a FET-based charge and photon-absorption sensor for molecular sensing. In the ELISA technique, the final step employs an antibody bound to an enzyme to catalyze the conversion of a colorless substrate into a colored product by signal amplification. The change of color or signal intensity is proportional to the target concentration for detection using a spectrophotometer. The most frequently used enzyme-conjugated antibody includes horseradish peroxidase (HRP), alkaline phosphatase (ALP), and b-galactosidase. Among the kinds of HRP-catalyzed colorimetric reactions, the HRP/3,30,5,50-tetramethylbenzidine (TMB) immunoassay system is commonly used in most of the commercial ELISAs. The present application demonstrates the ability of FET device to detect the molecule absorption of this signal amplification. Using the FET as a charge sensor to detect the binding between the capture antibody and NGAL. Furthermore, using the FET as a photodetector to observe the real-time absorption spectrum of oxidized tetramethylbenzidine (TMB) as a product of horseradish peroxide (HRP) assay and TMB substrate activity whereby the absorption signal increases with the NGAL concentration. That is, the present application concurrently demonstrates the detection of molecular charge and molecular absorption using a FET-based biosensor.

The method for detecting/monitoring a specimen by the FET-based bio-sensing sensor/system of the present application comprises following steps:

(i) determining a working wavelength. The working wavelength is determined by change of the light absorption spectrum of the color reaction (measured by change of the photocurrent of the FET). In this embodiment, the working wavelength is the characteristic wavelength of the enzymatic color reaction, which is about 650 nm.

(ii) calibrating a response of the sensor assembly under illumination of the working wavelength;

(iii) modifying at least a material A on the surface of the FET chip through the fluidic channel. The material A comprises the specimen. Then monitoring a dark current of the specimen passing through the fluidic channel.

(iv) adding a material B through the fluidic channel to react with the material A, and monitoring the dark current to confirm if the material A is modified and the charge change of the reaction of material A and B. The material A includes capture antibody modified on the FET surface, NGAL, Anti-NGAL antibody-biotin, Strepavidin-HRP and immunoadsorbent complex thereof. The material B includes TMB.

(v) monitoring a photocurrent under illumination of the working wavelength when the specimen passing through the fluidic channel; irradiating the light within working wavelength will induce color reaction to material A and B. The color reaction is TMB oxidase produced by the reaction of TMB and HRP.

(vi) determining an interaction between the specimen of interest and a probe molecule by analyzing the dark current and the photocurrent.

In one embodiment, the method further comprises step (v): determining an interaction between the specimen of interest and a probe molecule by analyzing the dark current and the photocurrent.

In one embodiment, step (iii) of the method further comprises:

### Example—Reagents and chemicals

A self-assembled monolayer reagent [3-aminopropyltriethoxysilane (APTES) solution], a cross-linking reagent [glutaraldehyde (GA)], ethanolamine (EA) and bovine serum albumin (BSA) were purchased from Sigma Aldrich Co. The Human Lipocalin-2/NGAL ELISA kit was purchased from R&D Systems. Dulbecco's phosphate buffered saline (1×PBS, 137 mM NaCl, 2.7 mM KCl, 10 mM Na₂HPO₄, 2 mM KH₂PO₄, pH 7.4) was purchased from Invitrogen. Diluted PBS from 1×PBS to 0.01×PBS was prepared using deionized water (DI water).

### FET Immobilization Procedure

The procedure of immobilization of capture antibody on the chip is as follows: The chip was first soaked in 2% cholic acid in ethanol for 12 h to clean and hydroxylase the surface of SiO₂, and then dried under a stream of nitrogen. The chip was then followed by soaking with APTES solution (2% in acetone) at room temperature (RT) for 1 h to form an amine group on the surface. The chip was then cleaned with distilled water and dried with nitrogen to remove unattached molecules and then was baked at 110° C. for 1 h. At this stage, the APTES modification was complete. Then, GA was allowed to react with the amino-terminated surface by immersing the chip in a solution of 12.5% 0.1×PBS for 1 h. Then, the monoclonal capture antibody (10 ng mL⁻¹) was allowed to covalently bind with the aldehyde of the GA-modified surface for 1 h. Then the FET-based biosensor of the present application is finished.

The manufacturing methods of FET chips and conventional FET biosensors are well known to person having ordinary skilled in the art. Their structures are shown in FIG. 2 (a), and will not go into details here. The present application mainly focuses on the dual function ELISA immunosensor with FET chip and its application.

### Detection Procedure

After the immobilization of the FET surface, the FET was then exposed to 0.1×PBS as a detection reference. The NGAL solution of different concentrations was added for measurement. A biotinylated secondary antibody (10 ng mL⁻¹) was then attached to the NGAL followed by a conjugated HRP-streptavidin (100 μL diluted in 1×PBS with a ratio of 1:40). In this step, the ELISA structure was immobilized over the FET surface. The light illumination at the wavelength of interest was turned on and off alternatively. A TMB (100 μL) was then introduced into the FET and the current versus time curves were measured for 25 minutes.

The step of immobilization (modification) with ELISA structure on the FET chip surface is an enzyme-linked immunosorbent reaction, which comprises following steps:

a) modification of a primary antibody (capture antibody) on the FET surface;

b) immunoadsorbing a primary protein (NGAL) to the primary antibody;

c) immunoadsorbing a secondary antibody (biotin) to the primary protein;

d) immunoadsorbing Strepavidin-HRP on the secondary antibody.

The present application does not limit the type of antibody and protein mentioned above.

### Photocurrent Measurement

A ray of visible light with tunable wavelength and light intensity is produced from a xenon light source (ASB-XE-175EX) and a monochromator (CM110) from Spectral Products Inc. FIG. 2 (b) shows the FET-base bio-sensing system of the present application. The bio-sensing system comprises a sensor assembly, a light source, a fluidic pump and an electrical measurement unit. The sensor assembly comprises an FET chip configured with at least one fluidic channel. The fluidic channel has an inlet and an outlet, and the fluidic pump is connected to the inlet of the fluidic channel and operable to drive a fluid and/or a specimen through the fluidic channel. The electrical measurement unit is connected to the sensor assembly to monitor a change in the electrical characteristics of the FET chip. The electrical measurement unit comprises a signal amplifier, a data acquisition unit and a computer

The visible light, passing through the fibreoptic cable, illuminates the sensing area of the biased FET. In a particular bias setting (source-drain voltage, back-gate voltage, and liquid-gate voltage), the drain current of the FET device was measured in the dark as well as under illumination. The light intensity of the source was calibrated using a commercial silicon photodiode PH-100Si from Gentech EO, Inc. Thus, the light source can be selected from a monochromator light source or a diode.

### Results

An ELISA sandwich structure is selected in this experiment (FIG. 1a). This structure required a capture antibody to detect NGAL. The sensing area of the FET that covered SiO₂ was functionalized with APTES and covalently bound to the capture antibodies specific for NGAL. The FET allows to detect the change in molecular charge in this binding. The final detection step uses an antibody bound to an HRP enzyme to catalyze the conversion of a colorless into a colored oxidized TMB. The concentration of NGAL, which is what the application want to determine, is proportional to the concentration of the produced oxidized TMB, and the latter is measured by photo-absorbance. As shown in FIG. 1b, the light at the specific wavelength is fully introduced into the FET sensing area from the top of the sensor assembly. When the light passes through the fluidic channel, photon absorption occurs on passage through the solution, and the surface molecules are measured using the FET device. This oxidized TMB can be real-time monitored through the FET device.

As shown in FIG. 2 (a), the FET chips used here are composed of a silicon wire between the source and drain electrodes. The n-type silicon FET biosensor was designed to operate in the accumulation mode, indicating that the device has a small drain current at zero gate voltage. For biosensing, it is advantageous to use this mode as the FET drain current changes depend on the charge of capture molecules becoming either more negative or positive upon interactions with target molecules. FIG. 2 (b) shows the deployment of the measurement system in our experiment that consists of electrical measurement, light sources and a pumping system. The drain current (I_{DS}) of the device was measured with a custom-made data acquisition platform current amplifier that enables the simultaneous measurement of all channel FETs. The present application characterized the electrical performance of silicon FETs to confirm their functionality as a biosensor. The device obtained a subthreshold swing of 215 mV dec⁻¹ and an on/off current ratio of about 10⁵. Additionally, the present application observed a pH response of the FET from pH4 to pH9. The sensitivity to pH showed the value of 45 mV This electrical performance indicated the stable interface state between the SiO₂ dielectric and the silicon gate sensing of FET during fabrication.

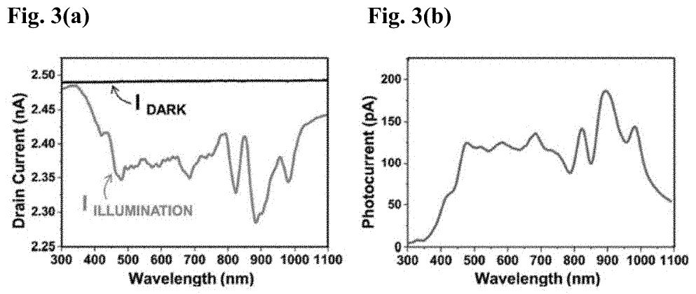

The photoresponse of FETs is then evaluated under the illumination of a light source with a wavelength ranging between 300 nm and 1100 nm. Upon illumination, the drain current increases or decreases depending on the factors such as photon wavelength, doping type, doping concentration, and possibly channel design. The drain current decreases upon illumination as shown in FIG. 3 (a). When used as a photodetector, the magnitude of the photocurrent matters more than its polarity; therefore, the present application defined photocurrent (Iₚₕ) as the absolute value of change in the drain current upon illumination, i.e., Iₚₕ=|I_{light}−I_{dark}|. The photocurrent spectrum suggests that our FET exhibits a good photoresponse in a broad wavelength ranging between 400 nm and 1000 nm (FIG. 3 (b)). The spectrum is taken with drain voltage (V_{DS}) at 0.5 V and back-gate voltage (V_{BG}) at 0.

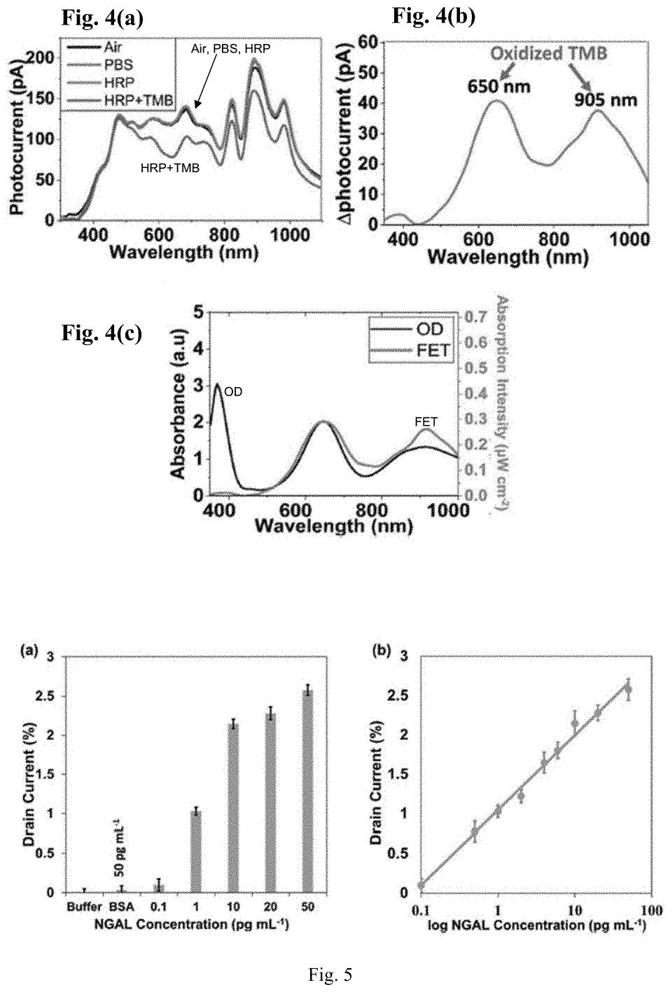

In the ELISA technique, the detection signal represents the molecular absorption due to the reaction of enzymatic activity. One of the popular enzyme-substrate reactions is horseradish peroxide (HRP) and 3,3′,5,5′-tetramethylbenzidine (TMB). Photocurrent measurements were conducted in which the FET was subjected to surface modification to enable the interaction between HRP and TMB to produce oxidized TMB. FIG. 4 shows the Photo-absorption spectrum of oxidized TMB measured using an FET the setup shown in FIG. 2 (b). FIG. 4 (a) shows the photocurrent spectrum under various conditions such as air, phosphate buffered saline (PBS), HRP, and HRP with TMB. The change of spectrum is due to a chemical reaction between the specimen and the probe molecule. The dark current corresponds to the change of the probe molecular charge, and the photocurrent corresponds to the molecular absorption of the probe molecule. The dark current is monitored when the light source is off, and the photocurrent is monitored while the light source is on. The dark current and the photocurrent under illumination of the working wavelength is monitored by rapidly switching the light source.

The spectra of air, PBS, and HRP in FIG. 4 (a) were shown to be similar. This means there were no absorption changes at the broad wavelength ranging 300 nm to 1100 nm. After the introduction of TMB, the emergence of oxidized TMB gradually turned the originally transparent PBS solution dark blue; the photocurrent curve “HRP+TMB” was taken after oxidized TMB saturation. FET photocurrent decreases due to the photo-absorption by oxidized TMB. The subtraction of spectra “HRP+TMB” and HRP is shown in FIG. 4 (b). Oxidized TMB shows a clear absorption at the photo wavelengths of 650 nm and 905 nm with the peaks of 41 pA and 39 pA, respectively. We measured the absorption spectrum of oxidized TMB using a commercial optical density (OD) spectro-photometer (JASCO V670). FIG. 4 (c) shows that the OD spectrum has three peaks visible at 370 nm, 650 nm, and 905 nm. By comparing the FET response, a vanished peak at 370 nm is associated with the insensitivity of the FET photoresponse under 400 nm.

Since oxidized TMB displays strong absorption at a wavelength of 650 nm, the present application calibrated the FET photoresponse at this wavelength. For this, the drain current vs. back-gate voltage characteristics (I_{D}-V_{BG}) under various light intensities at I=650 nm were investigated. The enhancement of light intensity leads to photocurrent following the power-law. For the bias condition, this dependence reads as the following formula:

I_{Ph} (μA)=6.34 A^{0.794} (1)

Where the light intensity A is in mW cm⁻². The results of the fitting equation (FIG. 4 (c)) allow the quantitative measurement of photo-absorption caused by molecular interactions. The aforementioned “calibration” procedure was applied at all wavelengths between 350 nm and 1000 nm, enabling the comparison with OD. This comparison confirms the capability of the FET in the quantitative detection of molecular photo-absorption of oxidized TMB.

In the present application, FET was used as a charge sensor for the detection of the change in molecular charge due to the binding between the NGAL and capture antibody. The use of the capture antibody as a receptor contributes to the determination of NGAL. Evaluation of the FET as a charge sensor was performed using different concentrations ranging from 0.1 to 50 pg mL⁻¹. The measurement results of various NGAL concentrations mentioned above under dark conditions are shown in FIG. 5 (a). The normalised change current is defined as:

$$DrainCurrent ( \% ) = \frac{Δ I}{Δ {I}_{0}} \qquad ( 2 )$$

Wherein ΔI and ΔI₀ are the change and initial values of the drain current, respectively. The drain current (%) is increased proportionally as the NGAL concentration increased in the above range.

These results suggested that this FET sensor is a promising tool for detecting specific targets. Additionally, the present application achieved a sensitivity of 0.1 pg mL⁻¹, which is well beyond the clinical useful level of NGAL in human serum of 40-160 ng mL⁻¹. In other words, this FET sensor is potentially applicable for other very lower range biomarkers in some diseases such as fetuin A(HFA) for atherosclerosis inflammatory disease and interleukin-6 (IL-6) for respiratory failure.22,23 We summarize the various immunosensor techniques reported for the detection of NGAL, and the results show that FET as a charge sensor exhibits great bioanalytical performance among all the methods with the highest sensitivity of 0.1 pg mL⁻¹ (see Table 1).

TABLE 1
NGAL detection technique comparison

| Sensor | Method | Range of detection | | Ref |
|---|---|---|---|---|
| Gold nanoparticles | CV | 50-250 | ng mL⁻¹ | 1 |
| Graphene nano platelets | ELISA | 0.5-5120 | pg mL⁻¹ | 2 |
| Carbon nanotubes | ELISA | 0.5-5120 | pg mL⁻¹ | 3 |
| Graphene/Polyaniline | CV | 50-250 | ng mL⁻¹ | 4 |
| Silicon | FET | 0.1-50 | pg mL⁻¹ | The present |
| | | | | application |

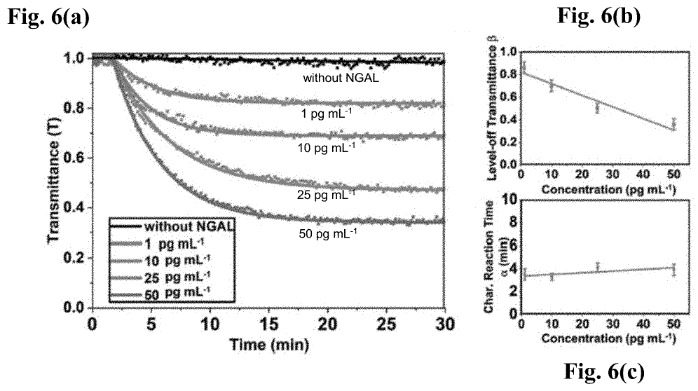

The NGAL was then attached to a biotinylated secondary antibody followed by a conjugated HRP-streptavidin as described in the above Experimental section. A powerful feature of FET chip of the present application is the ability to measure in real-time. In this setup, the FET was ready for photo-absorption measurements. After the introduction of the TMB molecule, the oxidized TMB product was generated upon the reaction with the HRP enzyme. The 650 nm light source was set to a low intensity of 1 μW cm⁻² to avoid any undesirable influence on the interaction between the TMB and conjugated HRP-streptavidin. Photocurrent measurements were conducted in the system over several on/off cycles in less than 25 minutes. The presence of oxidized TMB gradually turned the originally transparent PBS solution dark blue. The resulting photon absorption curve presented in FIG. 6 (a) shows the decrease in solution transparency resulting from the emergence of oxidized TMB. Transmittance traces (from up to low) correspond to NGAL concentrations without NGAL as control (upper), 1 pg mL⁻¹ (2nd), 10 pg mL⁻¹ (3rd), 25 pg mL⁻¹ (4th), and 50 pg mL⁻¹ (5th, lower). This signifies the existence of immobilized NGAL on the FET surface.

For quantitative evaluation, NGAL concentrations of 1 pg mL⁻¹, 10 pg mL⁻¹, 25 pg mL⁻¹, and 50 pg mL⁻¹ were tested. The photocurrent was then converted to the corresponding intensity using equation (1). The corresponding transmittance curves for different NGAL concentrations are shown in FIG. 6 (a). Before the introduction of TMB at 2 min, the transmittance is at the maximum due to the PBS solution's high transparency. After the introduction of TMB, the transmittance response due to the optical absorption decreases. This trend is described by an exponentially decaying function. For comparison, the present application shows the transmittance response. In this case, the intensity measured immediately before the introduction of TMB (when the PBS solution is transparent) was set to unity. It was found that the higher the NGAL concentration, the faster the decrease in intensity ratio. This relationship, however, levelled off at 25 min. The time dependence of the intensity ratio, γ(t), can be described by the following formula:

$$γ ( t ) = ( 100 - β ) {e}^{\frac{- t}{α}} + β \qquad ( 3 )$$

Wherein β is the levelling-off value at t=25 min. The TMB reaction time (a) is defined as the time the intensity drops to 37% of the full range (100-β). The levelling-off transmittance (3) decreases linearly with the NGAL concentration (FIG. 6 (b) and the characteristic time (a) is independent of the NGAL concentration (at about 3.8 min, FIG. 6 (c)), suggesting that the rate of converting TMB into oxidized TMB is a characteristic behavior of this process. The saturation value (3) has near-linear dependence on concentration, allowing for the quantitative determination of NGAL concentration.

### CONCLUSIONS

The integration of electrical and optical functions of FETs extends greatly the capability of present-day FET-based molecular sensors. Our devices have demonstrated a good photo response in a broad wavelength which is applicable for optical functions ranging between 400 nm and 1000 nm. Thus, enabling the detection of NGAL through oxidized TMB exhibits molecular absorption. When the device is used as a charge sensor, it possesses high detection sensitivity due to the inherent high charge-sensitive character of FETs. When used as a photosensor, it enjoys label-free detection getting around stringent surface modification required by FET charge sensors. For the quantitative detection of NGAL, the present application achieved a sensitivity of 0.1 pg m L⁻¹ when the FET was used as a charge sensor and <1 pg mL⁻¹ when used as a photosensor. Moreover, these features of the electro-optical FET sensor make it an excellent candidate for lab-on-chip integration which provides rapid, simple, and high sensitivity information for miscellaneous molecule detection.

In addition, the detecting method of the present application is not affected by the ion concentration. If the specimen has a high ion concentration, the traditional FET charge sensor is not suitable as a biomolecule detector. However, the light absorption is not affected by the ion concentration, so the light absorption sensor of the present application can still works normally.

The method of the present application monitor the molecular charge change (without light) and molecular absorption (with light) on the same platform (FET). The two detection mechanisms can be performed at the same time, and it is easy to compare with each other.

In addition, the FET bio-sensor of the present application can do the real-time detection of molecular absorption (measuring the amount of absorption over time, FIG. 6 (a)).. In contrast, the experiment needs to be terminated during detection in the conventional ELISA method. That is, the FET sensor of the present application has greater operational flexibility, and provides a real-time quantitative detection for the molecular concentration

In addition, the requirement of surface modification for light absorption detection is less than that for charge detection. If the specimen is a high-concentration ionic solution (charge change cannot be detected), the FET sensor of the present application can still carry out detection and has a lower cost than the traditional charge FET detector.

The present application takes the NGAL protein as specimen, but is not limited thereto. The person having ordinary skill in the art could modify the types of connecting molecules and/or probe molecules on the FET chip surface to match different specimen, including but not limited to DNA, RNA, proteins, peptides, enzymes, amino acids, antibodies, hormones, organic and inorganic pollutants, pesticides, chemicals, perfluorinated surfactants in water, or the combination thereof.

It will be apparent to those skilled in the art that various modifications and variations can be made to the disclosed embodiments. It is intended that the specification and examples be considered as exemplary only, with a true scope of the disclosure being indicated by the following claims and their equivalents.

### REFERENCES

1: P. Kannan, H. Y. Tiong and D. H. Kim, Highly sensitive electrochemical determination of neutrophil gelatinase-associated lipocalin for acute kidney injury, Biosens. Bioelectron., 2012, 31, 32-36.
2: S. K. Vashist, Graphene-based immunoassay for human lipocalin-2, Anal. Biochem., 2014, 446, 96-101.
3: S. K. Vashist and J. H. T. Luong, A rapid and highly sensitive immunoassay format for human lipocalin-2 using multi-walled carbon nanotubes, Biosens. Bioelectron., 2017, 93, 198-204.
4: J. Yukird, T. Wongtangprasert, R. Rangkupan, O. Chailapakul, T. Pisitkun and N. Rodthongkum, Label-free immunosensor based on graphene/polyaniline nano-composite for neutrophil gelatinase-associated lipocalin detection, Biosens. Bioelectron., 2017, 87, 249-255.

What is claimed is:

1. Afield effect transistor (FET)-based bio-sensing system, comprising:
a sensor assembly comprising an FET chip configured with at least one fluidic channel;
a light source;
a fluidic pump; and
an electrical measurement unit;
wherein the fluidic channel has an inlet and an outlet, and the fluidic pump is connected to the inlet of the fluidic channel and operable to drive a fluid and/or a specimen through the fluidic channel;
wherein the electrical measurement unit is connected to the sensor assembly to monitor a change in the electrical characteristics of the FET chip.

2. The FET-based bio-sensing system of claim 1, wherein the light source is a monochromator light source with a fiber connecting to the sensor assembly and/or a diode mounted on the sensor assembly.

3. The FET-based bio-sensing system of claim 1, wherein the electrical measurement unit comprises a signal amplifier, a data acquisition unit and a computer.

4. The FET-based bio-sensing system of claim 1, wherein the electrical characteristics contain information about both dark current and photocurrent; the photocurrent is the absolute value of the difference between the current under illumination of the light source and the dark current.

5. The FET-based bio-sensing system of claim 1, wherein the surface of the FET chip is modified with a linker molecule and a probe molecule.

6. The FET-based bio-sensing system of claim 1, the surface of the FET chip is modified with ELISA.

7. The FET-based bio-sensing system of claim 1, wherein the specimen comprises DNA, RNA, proteins, peptides, enzymes, amino acids, antibodies, hormones, organic and inorganic pollutants, pesticides, chemicals, perfluorinated surfactants in water, or the combination thereof.

8. A method for detecting a specimen by the FET-based bio-sensing system of claim 1, comprising following steps:
(i) determining a working wavelength;
(ii) calibrating a response of the sensor assembly under illumination of the working wavelength;
(iii) monitoring a dark current of the specimen passing through the fluidic channel; and
(iv) monitoring a photocurrent under illumination of the working wavelength when the specimen of interest passing through the fluidic channel.

9. The method of claim 8, further comprising following step:
(v) determining an interaction between the specimen of interest and a probe molecule by analyzing the dark current and the photocurrent.

10. The method of claim 8, wherein the step (iii) further comprising:
(iii-1) modifying at least a first material on the surface of the FET chip through the fluidic channel, wherein the first material comprises the specimen; and
(iii-2) adding a second material through the fluidic channel to react with the first material, and monitoring the dark current to confirm if the first material is modified and the charge change of the reaction of first material and the second material.

11. The method of claim 9, wherein the change of photocurrent is due to a chemical reaction between the specimen and the probe molecule.

12. The method of claim 11, wherein the chemical reaction is a color reaction.

13. The method of claim 12, wherein the color reaction is an enzymatic color reaction.

14. The method of claim 8, wherein the dark current corresponds to the change of the probe molecular charge.

15. The method of claim 8, wherein the photocurrent corresponds to the molecular absorption of the probe molecule.

16. The method of claim 8, wherein the dark current and the photocurrent under illumination of the working wavelength is monitored by rapidly switching the light source.

17. The method of claim 8, wherein the dark current is monitored when the light source is off.

18. The method of claim 8, wherein the photocurrent is monitored while the light source is on.
